(19) United States
(12) Patent Application Publication
(10) Pub. No.: US 2004/0228349 A1
(43) Pub. Date: Nov. 18, 2004

(54) Semi-distributed scheduling scheme for the reverse link of wireless systems

(76) Inventors: Sophie Vrzic, Nepean (CA); Mo-Han Fong, L'Orignal (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(21) Appl. No.: 10/751,951

(22) Filed: Jan. 7, 2004

Related U.S. Application Data
(60) Provisional application No. 60/439,239, filed on Jan. 10, 2003.

(51) Int. Cl. H04L 12/28

(52) U.S. Cl. 370/395.4

(57) ABSTRACT

In wireless communications systems, the Base Station Controller (BSC) and Base Transceiver Stations (BTSs) have schedulers which schedule soft handoff (SHO) users and non-soft handoff (NSHO) users regardless of delay sensitive users. The BSC's scheduler prioritizes the SHO users and calculates the available capacity at each sector. Then, with assigned data rates according to the priority, the available capacity is updated by the BSC's scheduler. The BTS's scheduler calculates the available capacity at the sector and with assigned data rates according to the priority of the NSHO users, the available capacity is updated. Based on the updated available capacity, packet data is transmitted at the scheduled data rate in the reverse link. With the schedules processed separately by the BSC and BTS, the multi-user diversity of states on the reverse link of wireless communications is efficiently supported.

### RELATED APPLICATIONS

The present invention claims priority from U.S. Provisional Patent Application Ser. No. 60/439,239 entitled “Semi-Distributed Scheduling Scheme for the Reverse Link of Wireless Systems” filed Jan. 10, 2003.

### FIELD OF THE INVENTION

The present invention is directed toward capacity enhancements for wireless networks, and more particularly toward scheduling to support packet-based wireless communications.

### BACKGROUND OF THE INVENTION

Code division multiple access (CDMA) communication systems provide communication services of wireless radio transmission of digitized speech, moving images, text messages and other types of data. The communication system's transmitter receives packets of the data The data rate transmitted in the packet in the reverse link (RL) of the wireless system is scheduled based on the parameters of the system. The total reverse link capacity is limited by the total interference generated by the mobile stations. The interference can be controlled by controlling the transmit power level of the mobile stations. The power level for the reverse link of each mobile station is controlled with reference to the ratio of the total energy and noise plus interference. The parameter based on the reverse link channel condition can be used for the calculation of the reverse link total load level. The load level has a direct correlation with the transmit power level. The reverse link total load level is used for the reverse link data rate scheduling. When the reverse link load level is high, in comparison to a low load level, fewer number of mobile stations may receive reverse link data communication at high data rate. It may be possible for reverse link scheduling in accordance with the carrier energy, noise and interference and based on associated Quality of Service (QoS) requirements.

U.S. patent application entitled “Resource allocation in a communication system supporting application flows having quality of service requirements” by T. Mukesh et al. (Publication No. 2003/0198204; Oct. 23, 2003) discloses a channel scheduler for forward and reverse links. However, it does not disclose a channel scheduler to schedule data transmissions in the wireless communications system including state diversity of mobile station users.

The wireless communication systems must support a multi-user diversity of states associated with user's mobile stations. The system must schedule, for example, soft handoff (SHO) users, non-soft handoff (NSHO) users, and autonomous users for data transmission. It is, therefore, necessary to achieve the capacity enhancement for wireless networks and properly schedule data transmissions, so as to efficiently support the multi-user diversity of states on the reverse link of packet-based wireless communications.

In order to efficiently support packet data services on the reverse link (RL) of wireless systems, the reverse link resource is dynamically allocated to a mobile station (MS) on an as-needed basis. The goal is to maximize the reverse link capacity or sector throughput, while maintaining an acceptable quality of service (QoS) and fairness (i.e., the manner in which the reverse link resource is shared among the mobile stations (MSs)). A scheduler is used to schedule users for transmission at a data rate, start time and duration determined by the scheduler. At each scheduling instance, one or more mobile stations are chosen for reverse link transmission based on factors such as QoS requirements, buffer occupancy and the reverse link channel condition of the MSs, as well as the fairness criteria among the different users. The data rate assigned to a mobile station is based on two key factors:

(i) the mobile's maximum supportable data rate, which is determined by its maximum transmit power, its RL channel condition and its buffer occupancy; and

(ii) the total interference that will be generated by the mobile station to each sector in the mobile's active set.

In order to maintain the stability of the system, the scheduler must also ensure that either the measured rise over thermal (RoT) (i.e., the total received power divided by the thermal noise) or the measured total received power of a sector does not exceed a required threshold value more than a specified percentage of time. For example, the RoT threshold value can be about 7 dB, while the percentage of time the RoT can exceed the RoT threshold is ideally in the vicinity of about 1 percent. If the RoT exceeds the RoT threshold then the QoS decreases for all users. Therefore, it is important to maintain the RoT below the RoT threshold. If a subscriber pays for better QoS (e.g., higher data rate), the user can be assigned a higher priority in order to obtain a higher data rate. In this case, a priority equation can be designed in order to schedule users with a higher QoS more often. There are three main types of scheduling schemes for the reverse link. These are distributed scheduling, centralized scheduling and rate control (or congestion control).

In a distributed scheduling scheme, the scheduler resides at the BTS. The scheduler uses either the mobile's current transmit power or the requested rate to assign a priority and a data rate for each mobile station. Since the scheduler is at the BTS, the scheduling delay (the difference between the time the scheduler schedules the mobile station and the time the mobile station actually transmits) is relatively short compared to a case where the scheduler resides at the BSC. In instances where the scheduler is located at the BTS, the scheduler can use more current information about the user's channel condition or the total received power at the BTS to decide which mobile stations and how many to schedule. However, the disadvantage of this approach is that it cannot easily schedule users in soft handoff, since it does not have any information of the neighbouring BTSs. When a BTS decides to schedule a user in soft handoff it might cause a high rise over thermal (RoT) for the other BTSs in the mobile's active set especially if the other BTSs did not schedule the mobile station at all. One solution to this problem is to let soft handoff users transmit autonomously at the lowest data rate, but this approach cannot take advantage of the available resources and therefore cannot maximize throughput. Also, fairness cannot be controlled using this method.

In a centralized scheduling scheme, the scheduler resides at the BSC. The advantage of this scheme is that the BSC can easily schedule the users in soft handoff, since the BSC can keep track of how much was scheduled at each BTS. The disadvantage of this scheme is that it results in a longer scheduling delay compared with the distributed scheduling scheme. Therefore, this approach cannot accommodate delay sensitive users with a short delay constraint. Also, the BSC will neither have the current total received power nor the mobile's current channel condition in order to take advantage of the available resources.

In a rate control scheme, the mobiles are sent a command to increase, decrease or hold their current data rate. Such a scheme does not explicitly schedule the mobile stations. The rate control command can be either dedicated or common to all the mobiles in a given sector. In common rate control, the BTS sends a single command to a group of mobiles or to all mobiles in the sector. In dedicated rate control, the BTS sends a command to each mobile individually. Because a mobile can only increase its data rate by only one step each resource allocation instance, there is a ramp up delay before a mobile can transmit at the higher data rates. This ramp up delay will affect the mobile's packet delay. If the rate control scheme is centralized rather than distributed this delay will be increase even further. However, a distributed rate control algorithm has the same problem in allocating resources to SHO users as distributed scheduling.

### SUMMARY OF THE INVENTION

It is an object of the present invention to provide an improved scheduler for properly scheduling data transmissions and efficiently supporting the multi-user diversity of states on the reverse link of packet-based wireless communications.

According to one aspect of the present invention, there is provided a scheduler for scheduling calls in wireless communications system comprising: a Base Station Controller for controlling various operating aspects of the system; and at least one Base Transceiver Station for providing communication links between mobile stations and between the mobile stations and a wireline telephone network, the mobile stations being associated with multi-diversity of user states, the scheduler scheduling the calls in reverse communication links based on the parameters of the system.

In the scheduler, scheduling functions are distributed to the Base Station Controller and the Base Transceiver Station in accordance with the types of the states associated with mobile stations. Therefore, the calls are separately scheduled depending upon the types of the mobile station states.

For example, the scheduling function performed by the Base Station Controller schedules calls of the mobile stations associated with soft handoff (SHO) state and the scheduling function performed by the Base Transceiver Station schedules calls of the mobile stations associated with non-soft handoff (NSHO) states. The SHO mobile stations are scheduled, regardless of whether they are delay sensitive, by the Base Station Controller. The NSHO mobile stations are scheduled, regardless of whether they are delay sensitive, by the Base Transceiver Station.

There are possibilities of locating a centralized scheduler in the Base Station Controller only (“BSC-centralized scheduler”) and of locating its scheduling functions in a plurality of Base Transceiver Stations only (“BTS-distributed scheduler”). Such BSC-centralized scheduler and BTS-distributed scheduler have drawbacks in a case where the wireless network includes multi-diversity of user mobile stations. In the BSC-centralized scheduler, lack of current information on the received power and the mobile channel condition, the Base Station Controller may not allocate available resources properly. Also, the Base Station Controller may not accommodate the delay sensitivity. In the BTS-distributed scheduler, due to lack of information on neighbouring BTSs, the SHO mobile stations may not be easily scheduled by the BTS's scheduler.

In an example of the present invention, the scheduling functions are distributed to the Base Station Controller and the Base Transceiver Station. The BSC's scheduler handles calls of the mobile stations associated with the SHO state and the BTS's scheduler handles calls of the mobile stations associated with the NSHO state. In this scheme, the BTS's scheduler does not require the scheduling of the SHO mobile stations and the BSC's scheduler does not require the scheduling of the NSHO mobile stations. Therefore, the scheduler consisting of both the BSC's and BTS's schedulers can allocate available resources properly and regardless of the delay sensitive mobile stations, they are easily scheduled.

Advantageously, in the BSC's scheduler, all mobile stations associated with the soft handoff (SHO) state are prioritized in accordance with priority criterion. The available capacity at each sector (j) is calculated in accordance with the Base Station Controller's load threshold and the load consumed by the autonomous data transmissions of the soft handoff mobile stations of the sector (j) that are active. The functions of assigning a data rate Rₘ and updating the available capacity are repeated with different values of the variable parameter until the parameter exceeds the number of the SHO mobile stations or the capacity becomes unavailable.

Similarly, in the BTS's scheduler, all mobile stations associated with the non-soft handoff (NSHO) state are prioritized in accordance with priority criterion. The available capacity at a sector (j) is calculated in accordance with the load threshold of the sector and the load consumed by all mobile stations associated with the soft handoff state scheduled by the Base Station Controller with the sector (j) that are active. The functions of assigning a data rate Rₘ and updating the available capacity are repeated with different values of the variable parameter until the parameter exceeds the number of the NSHO mobile stations or the capacity becomes unavailable.

According to other aspects of the present invention, there is provided a method for scheduling calls of the reverse link of packet-based wireless communications system and a system wherein the scheduler and/or method is implemented.

The scheduler of the reverse link can be used to significantly enhance third generation wireless systems. The algorithm can easily schedule soft-handoff users, non-soft handoff users and delay sensitive users, while maximizing throughput and ensuring the stability of the system.

### BRIEF DESCRIPTION OF THE DRAWINGS

The features, objects, and advantages of the present invention will become more apparent from the detailed description set forth below when taken in conjunction with the drawings in which like reference characters identify correspondingly throughout and wherein:

FIG. 1 illustrates the semi-distributed reverse link scheduling scheme according to an embodiment of the present invention;

FIG. 2 is a block diagram of a communication system that can operate in accordance with an embodiment of the present invention;

FIG. 3 is a flow diagram illustrating the operation of a scheduler that resides in the Base Station Controller (BSC) shown in FIG. 2; and

FIG. 4 is a flow diagram illustrating the operation of a scheduler that resides in the Base Transceiver Station (BTS) shown in FIG. 2.

### DETAILED DESCRIPTION

Rather than focus on a specific priority equation as discussed in the background, the present invention is instead directed toward multiple levels of scheduling. Soft Handoff (SHO) users are scheduled at a Base Station Controller (BSC) and non-soft handoff (NSHO) users are scheduled at a Base Transceiver Station (BTS), delay sensitive users can transmit autonomously.

The scheduler should also be able to handle both soft handoff (SHO) and non-soft handoff (NSHO) users. Because users in soft handoff have more than one sector in their active sets, a scheduler located at each BTS will result in high RoT outage. This is because a user in SHO can be scheduled by any member of its active set. If only one BTS schedules the user then only that BTS will account for the interference generated by the user. The other BTSs will experience higher interference than expected which would likely result in the RoT exceeding the required threshold. If the scheduler is located at the BSC (Base Station Controller) then the scheduler can account for the interference to each member of the active set. However, in this case, the scheduler will not have the user's current maximum supportable data rate because of the longer transmission latency between the mobile station and the BSC. In addition, the current loading information (RoT or total received power) of each sector is not readily available at the BSC, since this information needs to be transmitted from the BTSs to the BSC, thus it is subjected to the backhaul delay.

The present invention solves the problem of how to schedule both soft handoff (SHO) and non-soft handoff (NSHO) users for transmission on the reverse link, while, at the same time, maximizes throughput and ensures the stability of the system. It can also satisfy the requirements of delay sensitive traffic and ensure some degree of fairness among the different users.

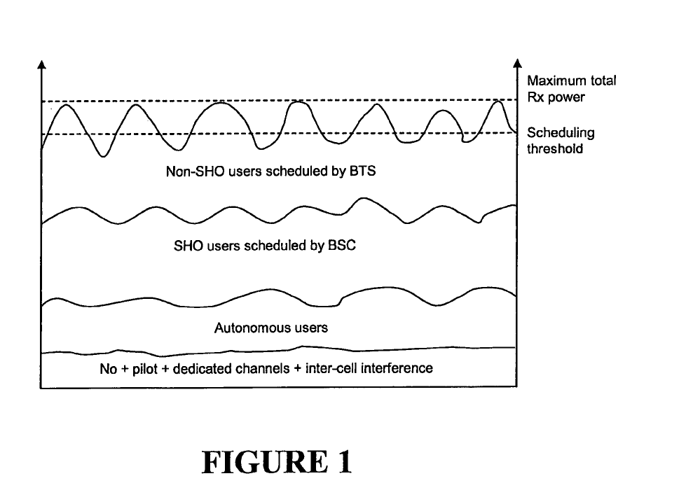

What is disclosed herein is a semi-distributed reverse link scheduling scheme. The present invention provides a solution to the problem of scheduling the users in soft handoff, while improving the throughput of the above algorithms and ensuring the stability of the system. In this new scheme, the SHO users (regardless of delay sensitive users) are scheduled by the BSC (centralized scheduling). The NSHO users (regardless of delay sensitive users) are scheduled by the BTS (distributed scheduling). Therefore, the “semi-distributed scheduling scheme” in the present invention includes SHO—centralized scheduling (by the BSC) and NSHO—distributed scheduling (by the BTS). The semi-distributed reverse link scheduling scheme according to an embodiment of the present invention is illustrated in FIG. 1. The total power includes:

(i) noise, load consumed by mobile stations (the transmissions on the pilot channel, control charnels, dedicated traffic channels) and inter-cell interference;

(ii) autonomous users' powers—loads consumed by the SHO and NSHO users with delay sensitive services;

(iii) SHO users' powers—loads consumed by the SHO users; and

(iv) NSHO users' powers—loads consumed by the NSHO users.

The scheduling threshold for the BTS depends on the variance of the total reverse link power. The threshold is determined in accordance with the maximum RoT and the percentage of time the maximum RoT is exceeded. The RoT threshold is predetermined to maintain the stability of the communication system.

In order to effectively manage the inter-cell interference, the BSC reserves a percentage of the available resources for scheduling the SHO users. This percentage, which can be different for different sectors, depends on the number of SHO users and NSHO users in the system, the type of users and the priority of each user. The percentage of the resources actually used for SHO users can either be fed back to each BTS or each BTS can measure the RoT or the total received power to determine the available capacity for scheduling the non-SHO users at the BTS. The advantage of using a centralized scheduler for SHO users is that each SHO user's received power at each sector in the active set can be considered in determining the available capacity. In a distributed scheme, this is not possible since the scheduler does not have any information from other BTSs in a mobile's active set. When a SHO mobile is scheduled by one of the members of its active set, the other members cannot account for the correct received power. The other members can account for the probability that the mobile will transmit at some rate, but this will lower throughput if the mobile doesn't transmit at all.

In the semi-distributed scheduling scheme according to an embodiment of the present invention, the impact of the longer scheduling delay at the BSC on throughput is minimized, since users in the SHO region do not contribute significantly to the system capacity.

In order to handle delay sensitive traffic, the semi-distributed scheduling scheme allows for autonomous transmission. When a delay sensitive mobile (SHO or NSHO) has traffic to send, it sends an estimate of its buffer size and its required data rate. The mobile station can transmit at any data rate up to the assigned maximum autonomous data rate without waiting for a scheduling grant. If the mobile receives a grant it will then transmit at the assigned data rate. After the mobile transmits the packet it goes back to the autonomous rate until it receives another grant or until its buffer is empty.

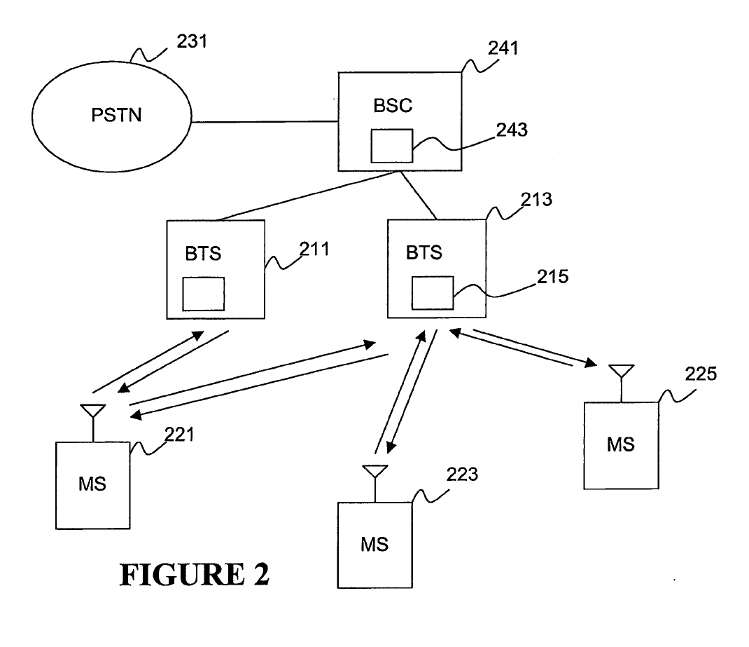

FIG. 2 shows a communication system that can operate in accordance with an embodiment of the present invention. In FIG. 2, the communication system includes a plurality of Base Transceiver Stations (BTSs) (here only two BTSs 211 and 213 are shown for simplicity). Each of the BTSs provides communication links among a plurality of mobile stations (MSs) (here only three MSs 221, 223 and 225 are shown for simplicity) and between the MSs and a wireline network such as the Public Switching Telephone Network (PSTN) 231. Each of the BTSs communicates with each other. A Base Station Controller (BSC) 241 controls communication operations in the system, the operation being in relation to a back haul between the PSTN 231 and the BTSs.

In a semi-distributed scheduling scheme according to an embodiment of the present invention, a scheduler is located at both the BTS 211, 213 and the BSC 241. Mobile stations in soft handoff (SHO) are scheduled by the BSC 241 containing a scheduler 243, while non-soft handoff (NSHO) mobile stations are scheduled by the BTS 211, 213 containing a scheduler 215. The benefit of using a semi-distributed scheduler is that it incorporates the advantages of both the centralized and distributed schedulers as discussed above.

Because the SHO users are scheduled by the BSC 241 (scheduler 243), there is no problem with budgeting for each of the SHO mobile stations that are scheduled as in the case of a completely distributed scheduling scheme. When the BSC 241 schedules a SHO user, it can budget for the user in each of the sectors in the mobile's active set. In this scheme, the BSC 241 reserves a percentage of the available reverse link resources for scheduling the SHO users. This percentage, which can be different for different sectors, depends on the number of active SHO and NSHO users in the system, the type of users and the priority of each user.

Due to the NSHO users being scheduled by the BTS 211, 213 (scheduler 215), the semi-distributed scheduling scheme can take advantage of the more recent information about each NSHO user's channel condition and the total received power at the BTS. Also, the shorter scheduling delay of the BTS scheduler reduces the packet delay of the NSHO users.

Although the SHO users will have a longer packet delay compared with the NSHO users, due to the longer scheduling delay, this will not significantly affect the overall average packet delay for a given sector since the SHO users do not contribute significantly to the system capacity.

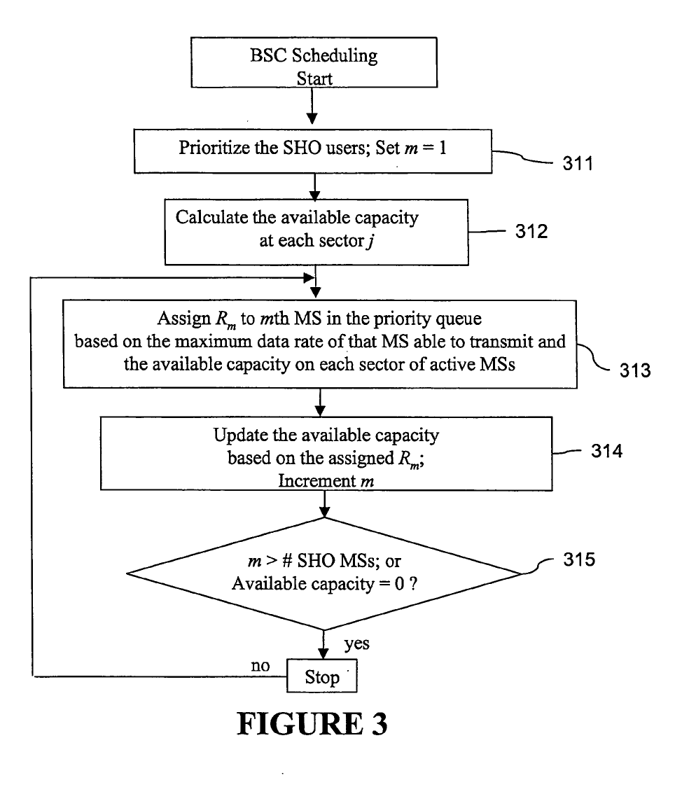

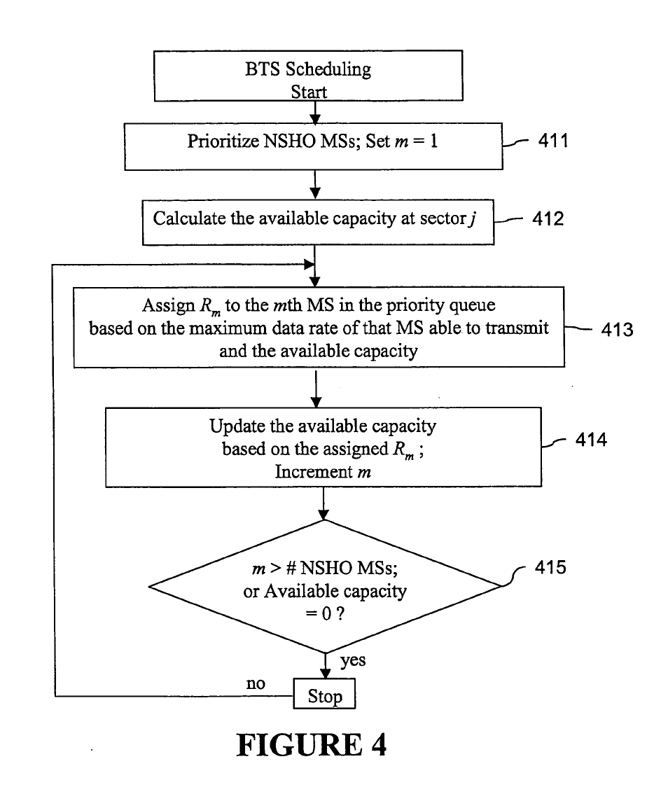

The scheduler 243 of the BSC 241 performs scheduling operation at each scheduling instance as shown in FIG. 3. The scheduler 215 of the BTS 211, 213 performs scheduling operation at each scheduling instance as shown in FIG. 4. The scheduling operation for the BSC 241 and the BTS 211, 213 in the semi-distributed scheduling scheme are described hereinafter.

The BSC scheduling operation will now be discussed with regard to FIG. 2. The BSC 241 shown in FIG. 2 includes a scheduler 243 that has a central processing unit and related data store means (not shown) to perform scheduling functions. The BSC's scheduler 243 performs scheduling operation at each scheduling instance as shown in FIG. 3. Referring to FIGS. 2 and 3, the scheduling operation by the BSC's scheduler 243 is described.

The scheduler 243 prioritizes all mobile stations in soft handoff (SHO) state in accordance with some priority equation (step 311). An example of the priority is given based on the factors of the geometry of the mobile station, the reverse link throughput of the mobile station and the fairness. An example of the priority equation is:

$${P}_{i} ( k ) = \frac{{[ {G}_{i} ]}^{α}}{{[ 1 + \overline{{R}_{i} ( k )} ]}^{β}} \qquad ( 1 )$$

where Pᵢ(k) is the priority of the ith mobile station (MS) at scheduling instance k,

Gᵢ is the primary-sector geometry of the ith MS;

\overline{Rᵢ(k)} is the infinite impulse response (IIR)-filtered RL throughput of the ith MS up to scheduling instance k; and

α and β are the exponents to control the fairness, respectively.

At step 311, upon of completion of the prioritization, the scheduler 243 of the BSC 241 sets parameter m to one.

The scheduler 243 calculates an initial available capacity at each sector j based on the BSC's load threshold and the SHOs' consumption load (step 312). The SHO mobile consumption load depends on the signal to interference plus noise (No) ratio for a SHO mobile, k, to one of its active set members, j, which is in general given by Sinrⱼ^{k}(R,E[R_{d}]). It includes transmissions on the pilot channel, control channels, dedicated traffic channels and transmissions on the R-PDCH at rate R.

Sinrⱼ^{k}(R,E[R_{d}]) is given by:

Sinrⱼ(R, E[R_{d}])=(E_{cp}/Nₜ)ⱼ[1+(T/P)_{R}+(T/P)_{d}+(T/P)_{SPICH}] (2)

where R is the data rate on the R-PDCH;

(E_{cp}/Nₜ)ⱼ is the pilot energy per chip divided by the total interference plus noise for sector j;

(T/P)_{R} is the traffic to pilot ratio for the data rate R;

(T/P)_{d} is the composite traffic to pilot ratio of all the dedicated traffic and control channels assigned to the mobile; and

(T/P)_{SPICH} is the traffic to pilot ratio of the secondary pilot channel.

The scheduler 243 subtracts the load threshold of the BSC 241 by the load (power) consumed by the mobile stations of the SHO state, with sector j as one of its active set members that will be either be retransmitting packets or will be transmitting at their autonomous rate. The load consumed by a mobile station includes the transmissions on the pilot channel, control channels (e.g., Reverse Channel Quality Indicator Channel, R-CQICH), dedicated traffic channels as well as transmissions on Reverse Packet Data Channel (R-PDCH). The available capacity for the BSC can be given by:

$${Cav}_{BSC} ( j ) = {X}_{BSC} ( j ) - {\sum }_{{k \vert SHO no retx ,}_{j ∈ ActiveSet ( k )}} \frac{{Sinr}_{j}^{k} ( {R}_{auto} , E [ {R}_{d} ] )}{1 + {Sinr}_{j}^{k} ( {R}_{auto} , E [ {R}_{d} ] )} \\ {\sum }_{{k \vert SHO with retx ,}_{j ∈ ActiveSet ( k )}} \frac{{Sinr}_{j}^{k} ( {R}_{retx} , E [ {R}_{d} ] )}{1 + {Sinr}_{j}^{k} ( {R}_{retx} , E [ {R}_{d} ] )} \qquad ( 3 )$$

where Cav_{BSC}(j) is the available capacity at sector j;

X_{BSC}(j) is the BSC load threshold for sector j;

Rₐᵤₜₒ to is the expected autonomous transmission rate;

Rᵣₑₜₓ is the retransmission rate;

Sinrⱼ^{k}(Rₐᵤₜₒ, E[R_{d}]) is the signal to interference plus noise ratio for a SHO mobile station, k, to one of its active set members, j, and it includes transmissions on the pilot channel, control channels, dedicated traffic channels and transmissions at the expected autonomous transmission rate Rₐᵤₜₒ;

Sinrⱼ^{k} (Rᵣₑₜₓ,E[R_{d}]) is the signal to interference plus noise ratio for a SHO mobile station, k, to one of its active set members, j, and it includes transmissions on the pilot channel, control channels, dedicated traffic channels and transmissions at the retransmission rate Rₐᵤₜₒ;

In accordance with Equation (2), Sinrⱼ^{k}(Rₐᵤₜₒ,E[R_{d}]) can be written as:

Sinrⱼ^{k}(Rₐᵤₜₒ,E[R_{d}])=(E_{cp}/Nₜ)ⱼ[1+(T/P)_{Rauto}+(T/P)_{d}+(T/P)_{SPICH}] (4)

Similarly, Sinrⱼ^{k}(Rᵣₑₜₓ,E[R_{d}]) can be written as:

Sinrⱼ^{k}(Rᵣₑₜₓ,E[R_{d}])=(E_{cp}/Nₜ)ⱼ[1+(T/P)_{Rretx}+(T/P)_{d}+(T/P)_{SPICH}] (5)

where (E_{cp}/Nₜ)ⱼ is the pilot energy per chip divided by the total interference plus noise for sector j;

(T/P)_{d} is the composite traffic to pilot ratio of all the dedicated traffic and control channels assigned to the mobile;

(TIP)_{SPICH} is the traffic to pilot ratio of the secondary pilot channel; and

(T/P)_{Rauto} is the traffic to pilot ratio for the autonomous rate Rₐᵤₜₒ. (T/P)_{Rretx} is the traffic to pilot ratio for the retransmission rate Rᵣₑₜₓ. Sinrⱼ^{k}(Rᵣₑₜₓ,E[R_{d}] is the signal to interference plus noise ratio for the mobile if the mobile transmits at the retransmission rate, Rᵣₑₜₓ on the R-PDCH given that it will also be transmitting on the pilot channel, the control channels and the dedicated traffic channels.

The scheduler 243 assigns a rate to a mobile station (step 313). For a mobile station in the mth position in the priority queue, with no hybrid automated repeat request (HARQ) packets pending, a rate Rₘ is assigned to that mobile station, based on the maximum data rate the mobile station can transmit on the R-PDCH (from the rate request information sent on R-REQCH) and the available capacity on each sector of the mobile station' active set. The rate Rₘ is given by:

$${R}_{m} = min \{ {R}_{max}^{m} ( s ) , {arg max}_{R} [ \begin{matrix}R \vert {Cav}_{BSC} ( j ) - \frac{{Sinr}_{j}^{m} ( R , E [ {R}_{d} ] )}{1 + {Sinr}_{j}^{m} ( R , E [ {R}_{d} ] )} + \\ \frac{{Sinr}_{j}^{m} ( {R}_{auto} , E [ {R}_{d} ] )}{1 + {Sinr}_{j}^{m} ( {R}_{auto} , E [ {R}_{d} ] )} \geq \\ 0 ; ∀ j ∈ ActiveSet ( m )\end{matrix} ] \} \qquad ( 6 )$$

where Rₘₐₓ is the maximum data rate that the mobile station can transmit on the R-PDCH;

R is the data rate on the R-PDCH;

Sinrⱼ^{m}(R,E[R_{d}]) is the signal to interference plus noise ratio for a SHO mobile station, m, to one of its active set members, j, and it includes transmissions on the pilot channel, control channels, dedicated traffic channels and transmissions on the R-PDCH at rate R; and

Sinrⱼ^{m} (R,E[R_{d}]) is the signal to interference plus noise ratio for a SHO mobile station, m, to one of its active set members, j, and it includes transmissions on the pilot channel, control channels, dedicated traffic channels and transmissions at the expected autonomous transmission rate Rₐᵤₜₒ.

The scheduler 243 updates the available capacity and increments parameter m (step 314). Before increment of m, the available capacity is updated using the rate Rₘ assigned at step 313, as follows:

$${{Cav}_{BSC} ( j )}_{upd} = {Cav}_{BSC} ( j ) - \frac{{Sinr}_{j}^{m} ( {R}_{m} , E [ {R}_{d} ] )}{1 + {Sinr}_{j}^{m} ( {R}_{m} , E [ {R}_{d} ] )} + \\ \frac{{Sinr}_{j}^{m} ( {R}_{auto} , E [ {R}_{d} ] )}{1 + {Sinr}_{j}^{m} ( {R}_{auto} , E [ {R}_{d} ] )} \qquad ( 7 )$$

where Cav_{BSC}(j)_{upd} is the updated available capacity at sector j;

Cav_{BSC}(j) is the initial available capacity at sector j or the pre-updated available capacity at sector j; and

Sinrⱼ^{m}(Rₘ,E[R_{d}]) is the signal to interference plus noise ratio for a SHO mobile station, m, to one of its active set members, j, and it includes transmissions on the pilot channel, control channels, dedicated traffic channels and transmissions at rate Rₘ.

Then, the scheduler 243 determines whether the assigning of rate and the updating of available capacity are repeated (step 315). The determination is made based on the number of the SHO mobile stations and the availability of the capacity. If the incremented m does not exceed the number of the SHO mobile stations or the capacity of each sector is still available (the negative determination at step 315), the scheduler 243 will repeat steps 313 and 314 for the assigning of rate and the updating of available capacity. Operations by Equations (6) and (7) are repeated and the available capacity at sector j, Cav_{BSC}(j), is updated.

If the incremented m exceeds the number of the SHO mobile stations or the capacity of each sector is no longer available (the positive at step 315), the scheduler 243 of the BSC 241 will stop the scheduling operation.

Each of the BTSs shown in FIG. 2 includes a scheduler therein. Here, a scheduler 215 included in the BTS 213 is described. The scheduler 215 has a central processing unit and related data store means (not shown) to perform scheduling functions. The BTS's scheduler 215 performs scheduling operation at each scheduling instance as shown in FIG. 4.

Referring to FIGS. 2 and 4, the scheduler 215 prioritizes all mobile stations in non-soft handoff (NSHO) in accordance with some priority equation (step 411). An example of the priority is given based on the factors of the geometry of the mobile station, the reverse link throughput of the mobile station and the fairness. An example of the priority equation is:

$${P}_{i} ( k ) = \frac{{[ {G}_{i} ]}^{α}}{{[ 1 + \overline{{R}_{i} ( k )} ]}^{β}} \qquad ( 8 )$$

where Pᵢ(k) is the priority of the ith mobile station (MS) at scheduling instance k;

Gᵢ is the primary-sector geometry of the ith MS;

\overline{Rᵢ(k)} is the IIR-filtered RL throughput of the ith MS up to scheduling instance k; and

α and β are the exponents to control the fairness, respectively.

At step 411, upon of completion of the prioritization, the scheduler 215 of the BTS 213 sets parameter m to one.

The scheduler 215 calculates an initial available capacity at sector j based on the sector load threshold, the SHOs' and NSHOs' consumption loads (step 412). The scheduler 215 subtracts the load threshold of that sector by the load (power) that will be consumed by all SHO mobile stations scheduled by the BSC 241 (the scheduler 243) with sector j as one of their active set members, at the same corresponding R-PDCH transmission period. It is also accounted for the retransmissions by the all the mobile stations and the remaining SHO and NSHO mobile stations by assuming that each mobile will be transmitting at their expected autonomous rate. The available capacity can be calculated using the equation:

$${Cav}_{BTS} ( j ) = X ( j ) - \\ {\sum }_{{k \vert BSC scheduled MS ,}_{j ∈ ActiveSet ( k )}} \frac{{Sinr}_{j}^{k} ( {R}_{sched} , E [ {R}_{d} ] )}{1 + {Sinr}_{j}^{k} ( {R}_{sched} , E [ {R}_{d} ] )} - \\ {\sum }_{{k \vert auto Tx ,}_{j ∈ ActiveSet ( k )}} \frac{{Sinr}_{j}^{k} ( {R}_{auto} , E [ {R}_{d} ] )}{1 + {Sinr}_{j}^{k} ( {R}_{auto} , E [ {R}_{d} ] )} - \\ {\sum }_{{k \vert with retx ,}_{j ∈ ActiveSet ( k )}} \frac{{Sinr}_{j}^{k} ( {R}_{retx} , E [ {R}_{d} ] )}{1 + {Sinr}_{j}^{k} ( {R}_{retx} , E [ {R}_{d} ] )} \qquad ( 9 )$$

where Cav_{BTS}(j) is the available capacity at sector j;

X(j) is the sector load threshold for sector j;

R_{sched} is the data rate that was scheduled by the BSC 241;

Rₐᵤₜₒ is the expected autonomous transmission rate;

Rᵣₑₜₓ is the retransmission rate;

Sinrⱼ^{k}(R_{sched},E[R_{d}]) is the signal to interference plus noise ratio for a SHO mobile station, k, to one of its active set members, j, and it includes transmissions on the pilot channel, control channels, dedicated traffic channels and transmissions at rate R_{sched};

Sinrⱼ^{k}(Rₐᵤₜₒ,E[R_{d}]) is the signal to interference plus noise ratio for a NSHO mobile station, k, to one of its active set members, j, and it includes transmissions on the pilot channel, control channels, dedicated traffic channels and transmissions at rate Rₐᵤₜₒ; and

Sinrⱼ^{k}(Rᵣₑₜₓ,E[R_{d}]) is the signal to interference plus noise ratio for a NSHO mobile station, k, to one of its active set members, j, and it includes transmissions on the pilot channel, control channels, dedicated traffic channels and transmissions at rate Rᵣₑₜₓ.

The scheduler 215 assigns a rate to a mobile station (step 413). For a mobile station in the mth position in the priority queue, the scheduler 215 assigns a rate Rₘ to the mobile station, based on the maximum data rate the mobile station can transmit on the R-PDCH (from the rate request information sent on R-REQCH) and the available capacity. The assigned data rate Rₘ is given by:

$${R}_{m} = min \{ {R}_{max}^{m} ( s ) , {arg max}_{R} [ \begin{matrix}R \vert {Cav}_{BTS} ( j ) - \frac{{Sinr}_{j}^{m} ( R , E [ {R}_{d} ] )}{1 + {Sinr}_{j}^{m} ( R , E [ {R}_{d} ] )} + \\ \frac{{Sinr}_{j}^{m} ( {R}_{auto} , E [ {R}_{d} ] )}{1 + {Sinr}_{j}^{m} ( {R}_{auto} , E [ {R}_{d} ] )} \geq \\ 0 ; ∀ j ∈ ActiveSet ( m )\end{matrix} ] \} \qquad ( 10 )$$

where Sinrⱼ^{m}(R,E[R_{d}]) is the signal to interference plus noise ratio for a NSHO mobile, m, to one of its active set members, j, and it includes transmissions on the pilot channel, control channels, dedicated traffic channels and transmissions at rate R; and

Sinrⱼ^{m}(Rₐᵤₜₒ,E[R_{d}]) is the signal to interference plus noise ratio for a NSHO mobile station, m, to one of its active set members, j, and it includes transmissions on the pilot channel, control channels, dedicated traffic channels and transmissions at the expected autonomous transmission rate Rₐᵤₜₒ.

The scheduler 215 updates the available capacity and increments parameter m (step 414). Before increment of m, the available capacity is updated using the rate Rₘ assigned at step 413, as follows:

$${{Cav}_{BTS} ( j )}_{upd} = {Cav}_{BTS} ( j ) - \frac{{Sinr}_{j}^{m} ( {R}_{m} , E [ {R}_{d} ] )}{1 + {Sinr}_{j}^{m} ( {R}_{m} , E [ {R}_{d} ] )} + \\ \frac{{Sinr}_{j}^{m} ( {R}_{auto} , E [ {R}_{d} ] )}{1 + {Sinr}_{j}^{m} ( {R}_{auto} , E [ {R}_{d} ] )} \qquad ( 11 )$$

where Cav_{BTS}(j)_{upd} is the updated available capacity at sector j;

Cav_{BTS}(j) is the initial available capacity at sector j or the pre-updated available capacity at sector j; and

Sinrⱼ^{m}(Rₘ,E[R_{d}]) is the signal to interference plus noise ratio for a NSHO mobile station, m, to one of its active set members, j, and it includes transmissions on the pilot channel, control channels, dedicated traffic channels and transmissions at rate Rₘ.

Then, the scheduler 215 determines whether the assigning of rate and the updating of available capacity are repeated (step 415). The determination is made based on the number of the NSHO mobile stations and the availability of the capacity. If the incremented m does not exceed the number of the NSHO mobile stations or the capacity of the sector is still available (the negative determination at step 415), the scheduler 215 will repeat steps 413 and 414 for the assigning of rate and the updating of available capacity. Operations by Equations (10) and (11) are repeated and the available capacity at sector j, Cav_{BTS}(j), is updated.

If the incremented m exceed the number of the NSHO mobile stations or the capacity of the sector is no longer available (the positive at step 415), the scheduler 215 of the BTS 213 will stop the scheduling operation.

It should be understood that the present invention is applicable to significantly enhance third generation wireless systems such as, but not limited to, 1xEV-DO, 1xEV-DV, MC-DV and UMTS/HSDPA. 1xEV-DO has been standardized by the Telecommunication Industry Association as TIA/EIA/IS-856, “CDMA2000, High Rate Packet Data Air Interface Specification”. 1xEV-DV provides integrated voice and simultaneous high-speed packet data multimedia services within CDMA2000 at speeds of up to 3.09 Mbps. Relatedly, MC-DV provides integrated multi-carrier voice and simultaneous high-speed packet data multimedia services within CDMA2000. UMTS/HSDPA is High Speed Downlink Packet Access (HSDPA) within the Universal Mobile Telephone System (UMTS). The present invention can easily schedule soft-handoff users, non-soft handoff users and delay sensitive users, while maximizing throughput and ensuring the stability of the given system.

Although particular embodiments of the present invention have been described in detail, it should be appreciated that numerous variations, modifications, and adaptations may be made without departing from the scope of the present invention as defined in the claims. For example, mobile stations may be prioritized by any equation or criteria. Also, the load, the available capacity and the data rate can be calculated using other equations.

What is claimed is:

1. A semi-distributed scheduler for scheduling calls in a wireless communications system wherein a Base Station Controller for controlling various operating aspects of the system and a Base Transceiver Station provides communication links between mobile stations and between the mobile stations and a wireline telephone network, the mobile stations being associated with multi-diversity of user states, the scheduler scheduling the reverse communication links based on the parameters of the system, the scheduler comprising:
means for scheduling in the Base Station Controller and the Base Transceiver Station in accordance with types of the user states associated with mobile stations.

2. The scheduler of claim 1, wherein the scheduling includes
means for scheduling the mobile stations separately in accordance with soft handoff (SHO) and non-soft handoff (NSHO) states.

3. The scheduler of claim 1, wherein the means for scheduling includes
a first scheduling unit that resides in the Base Station Controller for scheduling of the calls of the mobile stations associated with the SHO state, and
a second scheduling unit that resides in the Base Transceiver Station for scheduling of the calls of the mobile stations associated with the NSHO state.

4. The scheduler of claim 3, wherein the first scheduling unit includes
means for prioritizing all mobile stations associated with the soft handoff (SHO) state in accordance with priority criterion; and
means for calculating an initial available capacity at each sector j, in accordance with the Base Station Controller's load threshold and the load consumed by the soft handoff mobile stations of the sector j.

5. The scheduler of claim 4, wherein the first scheduling unit further includes
means for assigning a data rate Rₘ to a mobile station of the prioritized mobile stations in the mth position in a priority queue in accordance with the priority criterion, m being a variable parameter and an integer; and
means for updating the available capacity in accordance with the assigned data rate Rₘ, the updated available capacity being the difference between the initial available capacity or the pre-updated available capacity and the value calculated by noise and interferences.

6. The scheduler of claim 5, wherein the means for assigning a data rate Rₘ and means for the updating the available capacity are repeated with different values of the variable parameter until the parameter exceeds the number of the SHO mobile stations or the capacity becomes unavailable.

7. The scheduler of claim 4, wherein the means for calculating an initial available capacity at each sector j, Cav_{BSC}(j), includes means for performing the calculation of:
$${Cav}_{BSC} ( j ) = {X}_{BSC} ( j ) - {\sum }_{{k \vert SHO no retx ,}_{j ∈ ActiveSet ( k )}} \frac{{Sinr}_{j}^{k} ( {R}_{auto} , E [ {R}_{d} ] )}{1 + {Sinr}_{j}^{k} ( {R}_{auto} , E [ {R}_{d} ] )} - \\ {\sum }_{{k \vert SHO with retx ,}_{j ∈ ActiveSet ( k )}} \frac{{Sinr}_{j}^{k} ( {R}_{retx} , E [ {R}_{d} ] )}{1 + {Sinr}_{j}^{k} ( {R}_{retx} , E [ {R}_{d} ] )}$$
where X_{BSC}(j) is the BSC load threshold for sector j;
Rₐᵤₜₒ is the expected autonomous transmission rate;
Rᵣₑₜₓ is the retransmission rate;
Sinrⱼ^{k}(Rₐᵤₜₒ,E[R_{d}]) is the signal to interference plus noise ratio for a SHO mobile station, k, to one of its active set members, j, and includes transmissions on the pilot channel, control channels, dedicated traffic channels and transmissions at the expected autonomous transmission rate Rₐᵤₜₒ; and
Sinrⱼ^{k}(Rᵣₑₜₓ,E[R_{d}]) is the signal to interference plus noise ratio for a SHO mobile station, k, to one of its active set members, j, and includes transmissions on the pilot channel, control channels, dedicated traffic channels and transmissions at the retransmission rate Rᵣₑₜₓ.

8. The scheduler of claim 5, wherein the means for assigning a data rate Rₘ to a mobile station of the prioritized mobile stations includes means for assigning the data rate Rₘ based on the maximum data rate of the mth position's mobile station to transmit and the available capacity on each sector of the active mobile stations.

9. The scheduler of claim 8, wherein the means for assigning the data rate Rₘ to the mobile station includes means for performing the calculation of:
$${R}_{m} = min \{ {R}_{max}^{m} ( s ) , {arg max}_{R} [ \begin{matrix}R \vert {Cav}_{BSC} ( j ) - \frac{{Sinr}_{j}^{m} ( R , E [ {R}_{d} ] )}{1 + {Sinr}_{j}^{m} ( R , E [ {R}_{d} ] )} + \\ \frac{{Sinr}_{j}^{m} ( {R}_{auto} , E [ {R}_{d} ] )}{1 + {Sinr}_{j}^{m} ( {R}_{auto} , E [ {R}_{d} ] )} \geq \\ 0 ; ∀ j ∈ ActiveSet ( m )\end{matrix} ] \}$$
where Rₘₐₓ is the maximum data rate that the mobile station can transmit on the R-PDCH;
Sinrⱼ^{m} (R,E[R_{d}]) is the signal to interference plus noise ratio for a SHO mobile station, m, to one of its active set members, j, and includes transmissions on the pilot channel, control channels, dedicated traffic channels and transmissions on the R-PDCH at rate R; and
Sinrⱼ^{m}(Rₐᵤₜₒ,E[R_{d}]) is the signal to interference plus noise ratio for a SHO mobile station, m, to one of its active set members, j, and includes transmissions on the pilot channel, control channels, dedicated traffic channels and transmissions at the expected autonomous transmission rate Rₐᵤₜₒ.

10. The scheduler of claim 5, wherein the means for updating the available capacity in accordance with the assigned data rate Rₘ includes means for performing the calculation of:
$${{Cav}_{BSC} ( j )}_{upd} = {Cav}_{BSC} ( j ) - \frac{{Sinr}_{j}^{m} ( {R}_{m} , E [ {R}_{d} ] )}{1 + {Sinr}_{j}^{m} ( {R}_{m} , E [ {R}_{d} ] )} + \\ \frac{{Sinr}_{j}^{m} ( {R}_{auto} , E [ {R}_{d} ] )}{1 + {Sinr}_{j}^{m} ( {R}_{auto} , E [ {R}_{d} ] )}$$
where Cav_{BSC}(j)_{upd} is the updated available capacity at sector j;
Cav_{BSC}(j) is the initial available capacity at sector j or the pre-updated available capacity at sector j;
Sinrⱼ^{m}(Rₘ,E[R_{d}]) is the signal to interference plus noise ratio for a SHO mobile station, m, to one of its active set members, j, and includes transmissions on the pilot channel control channels, dedicated traffic channels and transmissions at rate Rₘ; and
Sinrⱼ^{m}(Rₐᵤₜₒ,E[R_{d}]) is the signal to interference plus noise ratio for a SHO mobile station, m, to one of its active set members, j, and includes transmissions on the pilot channel, control channels, dedicated traffic channels and transmissions at the expected autonomous transmission rate Rₐᵤₜₒ.

11. The scheduler of claim 3, wherein the second scheduling unit includes
means for prioritizing all mobile stations associated with the non-soft handoff (NSHO) state in accordance with priority criterion; and
means for calculating an initial available capacity at a sector j based on the load threshold of the sector and the load consumed by the mobile stations, wherein the consumed load includes the load consumed by all mobile stations associated with the soft handoff state scheduled by the Base Station Controller with the sector j and the load for the retransmissions by all mobile stations and the transmissions by the autonomous SHO and NSHO mobile stations.

12. The scheduler of claim 11, wherein the second scheduling unit further includes means for assigning a data rate Rₘ to a mobile station of the prioritized mobile stations in the mth position in a priority queue in accordance with the priority criterion; and
means for updating the available capacity in accordance with the assigned data rate Rₘ, the updated available capacity being the difference between the initial available capacity or the pre-updated available capacity and the value calculated by noise and interferences

13. The scheduler of claim 12, wherein the means for assigning a data rate Rₘ to a mobile station of the prioritized mobile stations includes
means for assigning the data rate Rₘ based on the maximum data rate of the mth position's mobile station to transmit and the available capacity on the sector of the active mobile stations.

14. The scheduler of claim 12, wherein the means for assigning a data rate Rₘ and the means for updating the available capacity are repeated with different values of the variable parameter until the parameter exceeds the number of the NSHO mobile stations or the capacity becomes unavailable.

15. The scheduler of claim 11, wherein the calculating an initial available capacity at a sector j, Cav_{BTS}(j), includes means for performing the calculation of:
$${Cav}_{BTS} ( j ) = X ( j ) - {\sum }_{{k \vert BSC scheduled MS ,}_{j ∈ ActiveSet ( k )}} \frac{{Sinr}_{j}^{k} ( {R}_{sched} , E [ {R}_{d} ] )}{1 + {Sinr}_{j}^{k} ( {R}_{sched} , E [ {R}_{d} ] )} - \\ {\sum }_{{k \vert auto Tx ,}_{j ∈ ActiveSet ( k )}} \frac{{Sinr}_{j}^{k} ( {R}_{auto} , E [ {R}_{d} ] )}{1 + {Sinr}_{j}^{k} ( {R}_{auto} , E [ {R}_{d} ] )} - \\ {\sum }_{{k \vert with retx ,}_{j ∈ ActiveSet ( k )}} \frac{{Sinr}_{j}^{k} ( {R}_{retx} , E [ {R}_{d} ] )}{1 + {Sinr}_{j}^{k} ( {R}_{retx} , E [ {R}_{d} ] )}$$
where X(j) is the sector load threshold for sector j;
R_{sched} is the data rate that was scheduled by the Base Station Controller;
Rₐᵤₜₒ is the expected autonomous transmission rate;
Rᵣₑₜₓ is the retransmission rate;
Sinrⱼ^{k}(R_{sched},E[R_{d}]) is the signal to interference plus noise ratio for a SHO mobile station, k, to one of its active set members, j, and includes transmissions on the pilot channel, control channels, dedicated traffic channels and transmissions at rate R_{sched};
Sinrⱼ^{k}(Rₐᵤₜₒ,E[R_{d}]) is the signal to interference plus noise ratio for a NSHO mobile station, k, to one of its active set members, j, and includes transmissions on the pilot channel, control channels, dedicated traffic channels and transmissions at rate Rₐᵤₜₒ; and
Sinrⱼ^{k}(Rᵣₑₜₓ,E[R_{d}]) is the signal to interference plus noise ratio for a NSHO mobile station, k, to one of its active set members, j, and includes transmissions on the pilot channel, control channels, dedicated traffic channels and transmissions at rate Rᵣₑₜₓ.

16. The scheduler of claim 13, wherein the means for assigning the data rate Rₘ to the mobile station includes means for performing the calculation of:
$${R}_{m} = min \{ {R}_{max}^{m} ( s ) , {arg max}_{R} [ \begin{matrix}R \vert {Cav}_{BSC} ( j ) - \frac{{Sinr}_{j}^{m} ( R , E [ {R}_{d} ] )}{1 + {Sinr}_{j}^{m} ( R , E [ {R}_{d} ] )} + \\ \frac{{Sinr}_{j}^{m} ( {R}_{auto} , E [ {R}_{d} ] )}{1 + {Sinr}_{j}^{m} ( {R}_{auto} , E [ {R}_{d} ] )} \geq \\ 0 ; ∀ j ∈ ActiveSet ( m )\end{matrix} ] \}$$
where Sinrⱼ^{m}(R,E[R_{d}]) is the signal to interference plus noise ratio for a NSHO mobile, m, to one of its active set members, j, and includes transmissions on the pilot channel, control channels, dedicated traffic channels and transmissions at rate R; and
Sinrⱼ^{m}(Rₐᵤₜₒ,E[R_{d}]) is the signal to interference plus noise ratio for a NSHO mobile station, m, to one of its active set members, j, and includes transmissions on the pilot channel, control channels, dedicated traffic channels and transmissions at the expected autonomous transmission rate Rₐᵤₜₒ.

17. The scheduler of claim 12, wherein the means for updating the available capacity in accordance with the assigned data rate Rₘ includes means for performing the calculation of:
$${{Cav}_{BTS} ( j )}_{upd} = {Cav}_{BTS} ( j ) - \frac{{Sinr}_{j}^{m} ( {R}_{m} , E [ {R}_{d} ] )}{1 + {Sinr}_{j}^{m} ( {R}_{m} , E [ {R}_{d} ] )} + \\ \frac{{Sinr}_{j}^{m} ( {R}_{auto} , E [ {R}_{d} ] )}{1 + {Sinr}_{j}^{m} ( {R}_{auto} , E [ {R}_{d} ] )}$$
where Cav_{BTS}(j)_{upd} is the updated available capacity at sector j;
Cav_{BTS}(j) is the initial available capacity at sector j or the pre-updated available capacity at sector j;
Sinrⱼ^{m}(Rₘ, E[R_{d}]) is the signal to interference plus noise ratio for a NSHO mobile station, m, to one of its active set members, j, and includes transmissions on the pilot channel, control channels, dedicated traffic channels and transmissions at rate Rₘ; and
Sinrⱼ^{m}(Rₐᵤₜₒ,E[R_{d}]) is the signal to interference plus noise ratio for a NSHO mobile station, m, to one of its active set members, j, and includes transmissions on the pilot channel, control channels, dedicated traffic channels and transmissions at the expected autonomous transmission rate Rₐᵤₜₒ.

18. A method for scheduling calls in a wireless communications system wherein a Base Station Controller controls various operating aspects of the system and a Base Transceiver Station provides communication links between mobile stations and between the mobile stations and a wireline telephone network, the mobile stations being associated with multi-diversity of user states, the method scheduling the reverse communication links based on the parameters of the system, the method comprising the step of:
scheduling in the Base Station Controller and the Base Transceiver Station in accordance with types of the states associated with the mobile stations.

19. The method of claim 18, wherein the step of scheduling includes the step of:
scheduling the mobile stations separately in accordance with soft handoff (SHO) and non-soft handoff (NSHO) states.

20. The method of claim 18, wherein the step of scheduling of the calls of the mobile stations includes the steps of:
performing the scheduling of calls of the mobile stations associated with the SHO state by the Base Station Controller; and
performing the scheduling of the calls of the mobile stations associated with the NSHO state by the Base Transceiver Station.

21. The method of claim 20, wherein the step of scheduling performed by the Base Station Controller includes the steps of:
prioritizing all mobile stations associated with the soft handoff (SHO) state in accordance with priority criterion; and
calculating an initial available capacity at each sector j, in accordance with the Base Station Controller's load threshold and the load consumed by the soft handoff mobile stations of the sector j.

22. The method of claim 21, wherein the step of scheduling performed by the Base Station Controller further includes the steps of:
assigning a data rate Rₘ to a mobile station of the prioritized mobile stations in the mth position in a priority queue in accordance with the priority criterion, m being a variable parameter and an integer; and
updating the available capacity in accordance with the assigned data rate Rₘ, the updated available capacity being the difference between the initial available capacity or the pre-updated available capacity and the value calculated by noise and interferences.

23. The method of claim 22, wherein the step of assigning a data rate includes the step of:
assigning the data rate based on the maximum data rate of the mth position's mobile station to transmit and the available capacity on each sector of the active mobile stations.

24. The method of claim 22, wherein the steps of assigning a data rate Rₘ and updating the available capacity are repeated with different values of the variable parameter until the parameter exceeds the number of the SHO mobile stations or the capacity becomes unavailable.

25. The method of claim 21, wherein the step of calculating an initial available capacity at each sector j, Cav_{BSC}(j), includes the step of performing the calculation of:
$${Cav}_{BSC} ( j ) = {X}_{BSC} ( j ) - {\sum }_{{k \vert SHO no retx ,}_{j ∈ ActiveSet ( k )}} \frac{{Sinr}_{j}^{k} ( {R}_{auto} , E [ {R}_{d} ] )}{1 + {Sinr}_{j}^{k} ( {R}_{auto} , E [ {R}_{d} ] )} - \\ {\sum }_{{k \vert SHO with retx ,}_{j ∈ ActiveSet ( k )}} \frac{{Sinr}_{j}^{k} ( {R}_{retx} , E [ {R}_{d} ] )}{1 + {Sinr}_{j}^{k} ( {R}_{retx} , E [ {R}_{d} ] )}$$
where X_{BSC}(j) is the BSC load threshold for sector j;
Rₐᵤₜₒ is the expected autonomous transmission rate;
Rᵣₑₜₓ is the retransmission rate;
Sinrⱼ^{k}(Rₐᵤₜₒ,E[R_{d}]) is the signal to interference plus noise ratio for a SHO mobile station, k, to one of its active set members, j, and includes transmissions on the pilot channel, control channels, dedicated traffic channels and transmissions at the expected autonomous transmission rate Rₐᵤₜₒ; and
Sinrⱼ^{k}(Rᵣₑₜₓ,E[R_{d}]) is the signal to interference plus noise ratio for a SHO mobile station, k, to one of its active set members, j, and includes transmissions on the pilot channel, control channels, dedicated traffic channels and transmissions at the retransmission rate Rᵣₑₜₓ.

26. The method of claim 22, wherein the assigning a data rate Rₘ to a mobile station of the prioritized mobile stations includes the step of:
assigning the data rate Rₘ based on the maximum data rate of the mth position's mobile station to transmit and the available capacity on each sector of the active mobile stations.

27. The method of claim 26, wherein the step of assigning the data rate Rₘ to the mobile station includes the step of performing the calculation of:
$${R}_{m} = min \{ {R}_{max}^{m} ( s ) , {arg max}_{R} [ \begin{matrix}R \vert {Cav}_{BSC} ( j ) - \frac{{Sinr}_{j}^{m} ( R , E [ {R}_{d} ] )}{1 + {Sinr}_{j}^{m} ( R , E [ {R}_{d} ] )} + \\ \frac{{Sinr}_{j}^{m} ( {R}_{auto} , E [ {R}_{d} ] )}{1 + {Sinr}_{j}^{m} ( {R}_{auto} , E [ {R}_{d} ] )} \geq \\ 0 ; ∀ j ∈ ActiveSet ( m )\end{matrix} ] \}$$
where Rₘₐₓ is the maximum data rate that the mobile station can transmit on the R-PDCH;
Sinrⱼ^{m}. (R,E[R_{d}]) is the signal to interference plus noise ratio for a SHO mobile station, m, to one of its active set members, j, and includes transmissions on the pilot channel, control channels, dedicated traffic channels and transmissions on the R-PDCH at rate R; and
Sinrⱼ^{m}(Rₐᵤₜₒ,E[R_{d}]) is the signal to interference plus noise ratio for a SHO mobile station, m, to one of its active set members, j, and includes transmissions on the pilot channel, control channels, dedicated traffic channels and transmissions at the expected autonomous transmission rate Rₐᵤₜₒ.

28. The method of claim 22, wherein the step of updating the available capacity in accordance with the assigned data rate Rₘ includes the step of performing the calculation of:
$${{Cav}_{BSC} ( j )}_{upd} = {Cav}_{BSC} ( j ) - \frac{{Sinr}_{j}^{m} ( {R}_{m} , E [ {R}_{d} ] )}{1 + {Sinr}_{j}^{m} ( {R}_{m} , E [ {R}_{d} ] )} + \\ \frac{{Sinr}_{j}^{m} ( {R}_{auto} , E [ {R}_{d} ] )}{1 + {Sinr}_{j}^{m} ( {R}_{auto} , E [ {R}_{d} ] )}$$
where Cav_{BSC}(j)_{upd} is the updated available capacity at sector j;
Cav_{BSC}(j) is the initial available capacity at sector j or the pre-updated available capacity at sector j;
Sinrⱼ^{m}(Rₘ,E[R_{d}]) is the signal to interference plus noise ratio for a SHO mobile station, m, to one of its active set members, j, and includes transmissions on the pilot channel, control channels, dedicated traffic channels and transmissions at rate Rₘ; and
Sinrⱼ^{m}(Rₐᵤₜₒ,E[R_{d}]) is the signal to interference plus noise ratio for a SHO mobile station, m, to one of its active set members, j, and includes transmissions on the pilot channel, control channels, dedicated traffic channels and transmissions at the expected autonomous transmission rate Rₐᵤₜₒ.

29. The method of claim 20, wherein the step of scheduling performed by the Base Transceiver Station includes the steps of:
prioritizing all mobile stations associated with the non-soft handoff (NSHO) state in accordance with priority criterion; and
calculating an initial available capacity at a sector j based on the load threshold of the sector and the load consumed by the mobile stations, wherein the consumed load includes the load consumed by all mobile stations associated with the soft handoff state scheduled by the Base Station Controller with the sector j and the load for the retransmissions by all mobile stations and the transmissions by the autonomous SHO and NSHO mobile stations.

30. The method of claim 29, wherein the step of scheduling performed by the Base Transceiver Station further includes the steps of:
assigning a data rate Rₘ to a mobile station of the prioritized mobile stations in the mth position in a priority queue in accordance with the priority criterion; and
updating the available capacity in accordance with the assigned data rate Rₘ, the updated available capacity being the difference between the initial available capacity or the pre-updated available capacity and the value calculated by noise and interferences

31. The method of claim 30, wherein the step of assigning a data rate Rₘ to a mobile station of the prioritized mobile stations includes:
assigning the data rate Rₘ based on the maximum data rate of the mth position's mobile station to transmit and the available capacity on the sector of the active mobile stations.

32. The method of claim 30, wherein the steps of assigning a data rate Rₘ and updating the available capacity are repeated with different values of the variable parameter until the parameter exceeds the number of the NSHO mobile stations or the capacity becomes unavailable.

33. The method of claim 29, wherein the step of calculating an initial available capacity at a sector j, Cav_{BTS}(j), includes the step of performing the calculation of:
$${Cav}_{BTS} ( j ) = X ( j ) - {\sum }_{{k \vert BSC scheduled MS ,}_{j ∈ ActiveSet ( k )}} \frac{{Sinr}_{j}^{k} ( {R}_{sched} , E [ {R}_{d} ] )}{1 + {Sinr}_{j}^{k} ( {R}_{sched} , E [ {R}_{d} ] )} - \\ {\sum }_{{k \vert auto Tx ,}_{j ∈ ActiveSet ( k )}} \frac{{Sinr}_{j}^{k} ( {R}_{auto} , E [ {R}_{d} ] )}{1 + {Sinr}_{j}^{k} ( {R}_{auto} , E [ {R}_{d} ] )} - \\ {\sum }_{{k \vert with retx ,}_{j ∈ ActiveSet ( k )}} \frac{{Sinr}_{j}^{k} ( {R}_{retx} , E [ {R}_{d} ] )}{1 + {Sinr}_{j}^{k} ( {R}_{retx} , E [ {R}_{d} ] )}$$
where X(j) is the sector load threshold for sector j;
R_{sched} is the data rate that was scheduled by the Base Station Controller,
Rₐᵤₜₒ is the expected autonomous transmission rate;
Rᵣₑₜₓ is the retransmission rate;
Sinrⱼ^{k}(R_{sched},E[R_{d}]) is the signal to interference plus noise ratio for a SHO mobile station, k, to one of its active set members, j, and includes transmissions on the pilot channel, control channels, dedicated traffic channels and transmissions at rate R_{sched};
Sinrⱼ^{k}(Rₐᵤₜₒ,E[R_{d}]) is the signal to interference plus noise ratio for a NSHO mobile station, k, to one of its active set members, j, and includes transmissions on the pilot channel, control channels, dedicated traffic channels and transmissions at rate Rₐᵤₜₒ; and
Sinrⱼ^{k}(Rᵣₑₜₓ,E[R_{d}]) is the signal to interference plus noise ratio for a NSHO mobile station, k, to one of its active set members, j, and includes transmissions on the pilot channel, control channels, dedicated traffic channels and transmissions at rate Rᵣₑₜₓ.

34. The method of claim 31, wherein the step of assigning the data rate Rₘ to the mobile station includes the step of performing the calculation of:
$${R}_{m} = min \{ {R}_{max}^{m} ( s ) , {arg max}_{R} [ \begin{matrix}R \vert {Cav}_{BTS} ( j ) - \frac{{Sinr}_{j}^{m} ( R , E [ {R}_{d} ] )}{1 + {Sinr}_{j}^{m} ( R , E [ {R}_{d} ] )} + \\ \frac{{Sinr}_{j}^{m} ( {R}_{auto} , E [ {R}_{d} ] )}{1 + {Sinr}_{j}^{m} ( {R}_{auto} , E [ {R}_{d} ] )} \geq \\ 0 ; ∀ j ∈ ActiveSet ( m )\end{matrix} ] \}$$
where Sinrⱼ^{m}(R,E[R_{d}]) is the signal to interference plus noise ratio for a NSHO mobile, m, to one of its active set members, j, and includes transmissions on the pilot channel, control channels, dedicated traffic channels and transmissions at rate R; and
Sinrⱼ^{m}(Rₐᵤₜₒ,E[R_{d}]) is the signal to interference plus noise ratio for a NSHO mobile station, m, to one of its active set members, j, and includes transmissions on the pilot channel, control channels, dedicated traffic channels and transmissions at the expected autonomous transmission rate Rₐᵤₜₒ.

35. The method of claim 30, wherein the step of updating the available capacity in accordance with the assigned data rate Rₘ includes the step of performing the calculation of:
$${{Cav}_{BTS} ( j )}_{upd} = {Cav}_{BTS} ( j ) - \frac{{Sinr}_{j}^{m} ( {R}_{m} , E [ {R}_{d} ] )}{1 + {Sinr}_{j}^{m} ( {R}_{m} , E [ {R}_{d} ] )} + \\ \frac{{Sinr}_{j}^{m} ( {R}_{auto} , E [ {R}_{d} ] )}{1 + {Sinr}_{j}^{m} ( {R}_{auto} , E [ {R}_{d} ] )}$$
where Cav_{BTS}(j)_{upd} is the updated available capacity at sector j;
Cav_{BTS}(j) is the initial available capacity at sector j or the pre-updated available capacity at sector j;
Sinrⱼ^{m}(Rₘ,E[R_{d}]) is the signal to interference plus noise ratio for a NSHO mobile station, m, to one of its active set members, j, and includes transmissions on the pilot channel, control channels, dedicated traffic channels and transmissions at rate Rₘ; and
Sinrⱼ^{m} (Rₐᵤₜₒ,E[R_{d}]) is the signal to interference plus noise ratio for a NSHO mobile station, m, to one of its active set members, j, and includes transmissions on the pilot channel, control channels, dedicated traffic channels and transmissions at the expected autonomous transmission rate Rₐᵤₜₒ.

36. A wireless communications system comprising:
a Base Station Controller for controlling various operating aspects of the system; and
at least one Base Transceiver Station for providing communication links between mobile stations and between the mobile stations and a wireline network, the mobile stations being associated with multi-diversity of user states,
wherein reverse communication links are scheduled in accordance with scheduling functions of a scheduler, the scheduling functions being based on the parameters of the system,
the scheduling functions being distributed between the Base Station Controller and the Base Transceiver Station of the communications system, in accordance with types of the states associated with mobile stations.

37. The system of claim 36, wherein the types of the states associated with the mobile stations includes soft handoff (SHO) and non-soft handoff (NSHO).

38. The system of claim 36, wherein:
the scheduling function distributed to the Base Station Controller includes the function of scheduling calls in the mobile stations associated with the SHO state; and
the scheduling function distributed to the Base Transceiver Station includes the function of scheduling calls in the mobile stations associated with the NSHO state.

39. The system of claim 38, wherein the Base Station Controller performs the scheduling functions of:
prioritizing all mobile stations associated with the soft handoff (SHO) state in accordance with priority criterion; and
calculating an initial available capacity at each sector j, in accordance with the Base Station Controller's load threshold and the load consumed by the soft handoff mobile stations of the sector j.

40. The system of claim 39, wherein the Base Station Controller further performs the functions of:
assigning a data rate Rₘ to a mobile station of the prioritized mobile stations in the mth position in a priority queue in accordance with the priority criterion, m being a variable parameter and an integer; and
updating the available capacity in accordance with the assigned data rate Rₘ, the updated available capacity being the difference between the initial available capacity or the pre-updated available capacity and the value calculated by noise and interferences.

41. The system of claim 40, wherein the functions of assigning a data rate Rₘ and updating the available capacity are repeated with different values of the variable parameter until the parameter exceeds the number of the SHO mobile stations or the capacity becomes unavailable.

42. The system of claim 39, wherein the function of calculating an initial available capacity at each sector j, Cav_{BSC}(j), includes the function of performing the calculation of:
$$\begin{matrix}{Cav}_{BSC} ( j ) = {X}_{BSC} ( j ) - {\sum }_{{k \vert SHO no retx ,}_{j ∈ ActiveSet ( k )}} \frac{{Sinr}_{j}^{k} ( {R}_{auto} , E [ {R}_{d} ] )}{1 + {Sinr}_{j}^{k} ( {R}_{auto} , E [ {R}_{d} ] )} - \\ {\sum }_{{k \vert SHO with retx ,}_{j ∈ ActiveSet ( k )}} \frac{{Sinr}_{j}^{k} ( {R}_{retx} , E [ {R}_{d} ] )}{1 + {Sinr}_{j}^{k} ( {R}_{retx} , E [ {R}_{d} ] )}\end{matrix}$$
where X_{BSC}(j) is the BSC load threshold for sector j;
Rₐᵤₜₒ is the expected autonomous transmission rate;
Rᵣₑₜₓ is the retransmission rate;
Sinrⱼ^{k}(Rₐᵤₜₒ,E[R_{d}]) is the signal to interference plus noise ratio for a SHO mobile station, k, to one of its active set members, j, and includes transmissions on the pilot channel, control channels, dedicated traffic channels and transmissions at the expected autonomous transmission rate Rₐᵤₜₒ; and
Sinrⱼ^{k}(Rᵣₑₜₓ,E[R_{d}]) is the signal to interference plus noise ratio for a SHO mobile station, k, to one of its active set members, j, and includes transmissions on the pilot channel, control channels, dedicated traffic channels and transmissions at the retransmission rate Rᵣₑₜₓ.

43. The system of claim 40, wherein the function of assigning a data rate Rₘ to a mobile station of the prioritized mobile stations includes the function of:
assigning the data rate Rₘ based on the maximum data rate of the mth position's mobile station to transmit and the available capacity on each sector of the active mobile stations.

44. The system of claim 43, wherein the function of assigning the data rate Rₘ to the mobile station includes the function of performing the calculation of:
$${R}_{m} = min \{ {R}_{max}^{m} ( s ) , {arg max}_{R} [ \begin{matrix}R \vert {Cav}_{BSC} ( j ) - \frac{{Sinr}_{j}^{m} ( R , E [ {R}_{d} ] )}{1 + {Sinr}_{j}^{m} [ R , E [ {R}_{d} ] )} + \\ \frac{{Sinr}_{j}^{m} ( R , E [ {R}_{d} ] )}{1 + {Sinr}_{j}^{m} [ R , E [ {R}_{d} ] )} \geq 0 ; \\ ∀ j ∈ ActiveSet ( m )\end{matrix} ] \}$$
where Rₘₐₓ is the maximum data rate that the mobile station can transmit on the R-PDCH;
Sinrⱼ^{m}(R,E[R_{d}]) is the signal to interference plus noise ratio for a SHO mobile station, m, to one of its active set members, j, and includes transmissions on the pilot channel, control channels, dedicated traffic channels and transmissions on the R-PDCH at rate R; and
Sinrⱼ^{m}(Rₐᵤₜₒ,E[R_{d}]) is the signal to interference plus noise ratio for a SHO mobile station, m, to one of its active set members, j, and includes transmissions on the pilot channel, control channels, dedicated traffic channels and transmissions at the expected autonomous transmission rate Rₐᵤₜₒ.

45. The system of claim 40, wherein the function of updating the available capacity in accordance with the assigned data rate Rₘ includes the function of performing the calculation of:
$$\begin{matrix}{{Cav}_{BSC} ( j )}_{upd} = {Cav}_{BSC} ( j ) - \frac{{Sinr}_{j}^{m} ( {R}_{m} , E [ {R}_{d} ] )}{1 + {Sinr}_{j}^{m} ( {R}_{m} , E [ {R}_{d} ] )} + \\ \frac{{Sinr}_{j}^{m} ( {R}_{auto} , E [ {R}_{d} ] )}{1 + {Sinr}_{j}^{m} ( {R}_{auto} , E [ {R}_{d} ] )}\end{matrix}$$
where Cav_{BSC}(j)_{upd} is the updated available capacity at sector j;
Cav_{BSC}(j) is the initial available capacity at sector j or the pre-updated available capacity at sector j;
Sinrⱼ^{m}(Rₘ,E[R_{d}]) is the signal to interference plus noise ratio for a SHO mobile station, m, to one of its active set members, j, and includes transmissions on the pilot channel, control channels, dedicated traffic channels and transmissions at rate Rₘ; and
Sinrⱼ^{m}(Rₐᵤₜₒ,E[R_{d}]) is the signal to interference plus noise ratio for a SHO mobile station, m, to one of its active set members, j, and includes transmissions on the pilot channel, control channels, dedicated traffic channels and transmissions at the expected autonomous transmission rate Rₐᵤₜₒ.

46. The system of claim 38, wherein the Base Transceiver Station performs scheduling functions of:
prioritizing all mobile stations associated with the non-soft handoff (NSHO) state in accordance with priority criterion; and
calculating an initial available capacity at a sector j based on the load threshold of the sector and the load consumed by the mobile stations, wherein the consumed load includes the load consumed by all mobile stations associated with the soft handoff state scheduled by the Base Station Controller with the sector j and the load for the retransmissions by all mobile stations and the transmissions by the autonomous SHO and NSHO mobile stations.

47. The system of claim 46, wherein the Base Transceiver Station further performs the functions of:
assigning a data rate Rₘ to a mobile station of the prioritized mobile stations in the mth position in a priority queue in accordance with the priority criterion; and
updating the available capacity in accordance with the assigned data rate Rₘ, the updated available capacity being the difference between the initial available capacity or the pre-updated available capacity and the value calculated by noise and interferences

48. The system of claim 47, wherein the function of assigning a data rate Rₘ to a mobile station of the prioritized mobile stations includes the function of:
assigning the data rate Rₘ based on the maximum data rate of the mth position's mobile station to transmit and the available capacity on the sector of the active mobile stations.

49. The system of claim 47, wherein the functions of assigning a data rate Rₘ and updating the available capacity are repeated with different values of the variable parameter until the parameter exceeds the number of the NSHO mobile stations or the capacity becomes unavailable.

50. The system of claim 48, wherein the function of calculating an initial available capacity at a sector j, Cav_{BTS}(j), includes the function of performing the calculation of:
$$\begin{matrix}{Cav}_{BTS} ( j ) = X ( j ) - {\sum }_{{k \vert BSC scheduled MS ,}_{j ∈ ActiveSet ( k )}} \frac{{Sinr}_{j}^{k} ( {R}_{sched} , E [ {R}_{d} ] )}{1 + {Sinr}_{j}^{k} ( {R}_{sched} , E [ {R}_{d} ] )} - \\ {\sum }_{{k \vert auto Tx ,}_{j ∈ ActiveSet ( k )}} \frac{{Sinr}_{j}^{k} ( {R}_{auto} , E [ {R}_{d} ] )}{1 + {Sinr}_{j}^{k} ( {R}_{auto} , E [ {R}_{d} ] )} - \\ {\sum }_{{k \vert with Tx ,}_{j ∈ ActiveSet ( k )}} \frac{{Sinr}_{j}^{k} ( {R}_{retx} , E [ {R}_{d} ] )}{1 + {Sinr}_{j}^{k} ( {R}_{retx} , E [ {R}_{d} ] )}\end{matrix}$$
where X(j) is the sector load threshold for sector j;
R_{sched} is the data rate that was scheduled by the Base Station Controller,
Rₐᵤₜₒ is the expected autonomous transmission rate;
Rᵣₑₜₓ is the retransmission rate;
Sinrⱼ^{k}(R_{sched},E[R_{d}]) is the signal to interference plus noise ratio for a SHO mobile station, k, to one of its active set members, j, and includes transmissions on the pilot channel, control channels, dedicated traffic channels and transmissions at rate R_{sched};
Sinrⱼ^{k}(Rₐᵤₜₒ,E[R_{d}]) is the signal to interference plus noise ratio for a NSHO mobile station, k, to one of its active set members, j, and includes transmissions on the pilot channel, control channels, dedicated traffic channels and transmissions at rate Rₐᵤₜₒ; and
Sinrⱼ^{k}(Rᵣₑₜₓ,E[R_{d}]) is the signal to interference plus noise ratio for a NSHO mobile station, k, to one of its active set members, j, and includes transmissions on the pilot channel, control channels, dedicated traffic channels and transmissions at rate Rᵣₑₜₓ.

51. The system of claim 49, wherein the function of assigning the data rate Rₘ to the mobile station includes the function of performing the calculation of:
$${R}_{m} = min \{ {R}_{max}^{m} ( s ) , {arg max}_{R} [ \begin{matrix}R \vert {Cav}_{BTS} ( j ) - \frac{{Sinr}_{j}^{m} ( R , E [ {R}_{d} ] )}{1 + {Sinr}_{j}^{m} [ R , E [ {R}_{d} ] )} + \\ \frac{{Sinr}_{j}^{m} ( {R}_{auto} , E [ {R}_{d} ] )}{1 + {Sinr}_{j}^{m} [ {R}_{auto} , E [ {R}_{d} ] )} \geq 0 ; \\ ∀ j ∈ ActiveSet ( m )\end{matrix} ] \}$$
where Sinrⱼ^{m}(R,E[R_{d}]) is the signal to interference plus noise ratio for a NSHO mobile, m, to one of its active set members, j, and includes transmissions on the pilot channel, control channels, dedicated traffic channels and transmissions at rate R; and
Sinrⱼ^{m}(Rₐᵤₜₒ,E[R_{d}]) is the signal to interference plus noise ratio for a NSHO mobile station, m, to one of its active set members, j, and includes transmissions on the pilot channel, control channels, dedicated traffic channels and transmissions at the expected autonomous transmission rate Rₐᵤₜₒ.

52. The system of claim 47, wherein the function of updating the available capacity in accordance with the assigned data rate Rₘ includes the function of performing the calculation of:
$$\begin{matrix}{{Cav}_{BTS} ( j )}_{upd} = {Cav}_{BTS} ( j ) - \frac{{Sinr}_{j}^{m} ( {R}_{m} , E [ {R}_{d} ] )}{1 + {Sinr}_{j}^{m} ( {R}_{m} , E [ {R}_{d} ] )} + \\ \frac{{Sinr}_{j}^{m} ( {R}_{auto} , E [ {R}_{d} ] )}{1 + {Sinr}_{j}^{m} ( {R}_{auto} , E [ {R}_{d} ] )}\end{matrix}$$
where Cav_{BTS}(j)_{upd} is the updated available capacity at sector j;
Cav_{BTS}(j) is the initial available capacity at sector j or the pre-updated available capacity at sector j;
Sinrⱼ^{m}(Rₘ,E[R_{d}]) is the signal to interference plus noise ratio for a NSHO mobile station, m, to one of its active set members, j, and includes transmissions on the pilot channel, control channels, dedicated traffic channels and transmissions at rate Rₘ; and
Sinrⱼ^{m}(Rₐᵤₜₒ,E[R_{d}]) is the signal to interference plus noise ratio for a NSHO mobile station, m, to one of its active set members, j, and includes transmissions on the pilot channel, control channels, dedicated traffic channels and transmissions at the expected autonomous transmission rate Rₐᵤₜₒ.
